(19) United States
(12) Patent Application Publication
(10) Pub. No.: US 2022/0388001 A1
(43) Pub. Date: Dec. 8, 2022

(54) DEVICE AND METHOD FOR DEFINED LEVEL ADJUSTMENT OF A FLOWABLE MEDIUM IN A HOLLOW BODY

(71) Applicant: Dr. Hielscher GmbH, Teltow (DE)

(72) Inventors: Thomas HIELSCHER, Potsdam (DE); Holger HIELSCHER, Rangsdorf (DE); Harald HIELSCHER, Stahnsdorf (DE)

(73) Assignee: Dr. Hielscher GmbH, Teltow (DE)

(21) Appl. No.: 17/830,549

(22) Filed: Jun. 2, 2022

(30) Foreign Application Priority Data
Jun. 3, 2021 (DE) 102021114410.8

(51) Int. Cl. B01L 3/00

(52) U.S. Cl. CPC B01L 3/502746; B01L 2300/0877

(57) ABSTRACT

Systems and methods define adjustment of the level of a flowable medium in a hollow body. The systems and methods have a tank that is suitable for filling with a flowable medium, a hollow body with one or more openings, and one or more channels that each with a channel inlet and a channel outlet. The channels are disposable such that after placing the hollow body in the filled tank, in those regions of the hollow body in which imprisoned volumes of gas are situated between the wall of the hollow body and the flowable medium, at least one respective channel inlet is situated and is connected through the one channel to a channel outlet that is situated outside the hollow body and outside the flowable medium.

### TECHNICAL FIELD OF THE DISCLOSURE

The present invention relates to a device as well as to a method for defined adjustment of a level of a flowable medium in a hollow body.

### BACKGROUND OF THE DISCLOSURE

Microtitre plates are used for a very wide variety of microbiological operations. Examples of typical areas of application are cell culture or screening of technical biological reactions. Because of the large number of cavities and the use of similar types, microtitre plates are suitable for culture and for tests with a large number of samples.

In many applications, for a certain period, the microtitre plates are exposed to oscillations, usually resonant oscillations. To this end, the underside of the microtitre plate may be configured as a hollow body with an opening. This hollow body is partially immersed in a tank filled with a flowable medium—for example an aqueous solution—in a manner such that the opening of the hollow body is located below the surface (the level) of the flowable medium. Next, the tank is oscillated. These oscillations are trans-ferred to the microtitre plate by means of the flowable medium and therefore also to the liquid suspensions the biological or biochemical properties of which are to be investigated located in a plurality of wells located on the upper side of the microtitre plate. The oscillatory properties of this system formed by the microtitre plate (hollow body), tank and flowable medium are in this regard essentially determined by the geometry—i.e. the spatial organisation or extent—of the flowable medium, which takes this up when it is in the tank and the hollow body is partially immersed in the flowable medium.

Because the underside of the microtitre plate—or more generally: the hollow body—could have irregularities when partially immersed in the flowable medium, for example elevations and depressions, when the microtitre plate or hollow body is lowered, gas from the surrounding atmosphere (for example air) can be imprisoned in those regions between the microtitre plate/hollow body and flowable medium in which the underside of the microtitre plate or the hollow body has elevations. These volumes of gas imprisoned between the microtitre plate/hollow body and flowable medium upon lowering the microtitre plate or the hollow body can then displace the flowable medium downwards and in this way cause the level of the flowable medium in these regions to fall compared with the level of the flowable medium outside these regions, in particular outside the region of the microtitre plate/hollow body. Occasionally, in regions outside the microtitre plate/hollow body, the level of the flowable medium could even rise in that there, the volume of the flowable medium displaced by the aforementioned imprisoned gas volume is at least partially taken up. Corresponding displacement effects may naturally also occur when the microtitre plate or the hollow body is initially positioned in a suitable (predefined) manner in the tank and the tank is only then filled with the flowable medium.

Because of the aforementioned difference in levels of the flowable medium, the oscillatory properties of the flowable medium—and therefore also the oscillatory properties of the whole system formed by the microtitre plate (including the suspensions in the wells to be investigated) or the hollow body can be influenced in an unwanted manner. In addition, defined differences in levels may, however, also be specifically exploited in order to obtain specific oscillatory properties or effects. In any case, it is advantageous to be able to specifically adjust the level of the flowable medium in those regions in which, upon placing the microtitre plate/hollow body in the tank filled with a flowable medium—or alternatively when filling the tank in which the microtitre plate/hollow body has already been suitably positioned—a displacement of the flowable medium takes place.

Thus, the objective of the present invention is to provide a technical solution—in particular a system and a method—with which the level of a flowable medium can be influenced, varied or adjusted in regions in which the flowable medium is displaced or has been displaced by volumes of gas which are located between a hollow body partially immersed in the flowable medium and the flowable medium itself. An influence, variation or adjustment of the level of this type can be obtained with the systems and methods disclosed herein.

### SUMMARY OF THE DISCLOSURE

The invention is defined in the accompanying claims. The description of the invention below supports the delimitations defined in these claims. Any disclosure which lies outside the scope of desired protection defined in the claims is purely by way of illustration or for comparison purposes.

In a first aspect, the invention concerns a system for defined adjustment of the level of a flowable medium in a hollow body. In this regard, the system has: a tank which is suitable for filling with a flowable medium; a hollow body with one or more openings; one or more channels each with a channel inlet (inlet opening) and a channel outlet (outlet opening). In this regard, the hollow body can be placed in the tank in a manner such that each of the one or more openings of the hollow body is respectively located completely below the surface (the level) of the flowable medium when the tank is filled with the flowable medium and a predefined minimum fill volume of flowable medium is situated in the tank. The channel is or the channels are respectively positioned in a manner such that after placing the hollow body in the tank filled with at least the minimum fill volume of the flowable medium, in those regions of the hollow body in which imprisoned volumes of gas are situated between the wall of the hollow body and the flowable medium, at least one respective channel inlet is situated and is connected through the one channel or one of the plurality of channels to a channel outlet which is situated outside the hollow body and outside the flowable medium.

In a second aspect, the invention concerns a method for a defined adjustment of the fill level of a flowable medium in a hollow body, with the following steps:
a) providing a tank;
b) filling the tank with a flowable medium to a predefined fill height or to at least one predefined minimum fill height;
c) placing a hollow body in the tank in a manner such that the opening or the openings of the hollow body are respectively disposed below the level of the flowable medium situated in the tank;
d) in the event that this step d) is carried out after step c): positioning or mounting one or more channels each with a channel inlet and a channel outlet on the hollow body or on the tank in a manner such that at least one channel inlet is situated in each contiguous gas volume which is delimited by one or more internal walls of the hollow body as well as by the flowable medium, and wherein the channel outlets are respectively situated outside the hollow body and out of the flowable medium; or in the event that this step d) is carried out before step c): positioning or mounting one or more channels each with a channel inlet and a channel outlet on the hollow body or on the tank in a manner such that at least one channel inlet is situated in each contiguous gas volume which is formed and which is delimited by one or more internal walls of the hollow body as well as by the flowable medium as soon as the hollow body is placed in the filled tank in accordance with step c), and wherein the channel outlets are respectively situated outside the hollow body and outside the flowable medium as soon as step b) and step c) have been carried out.

In a third aspect, the invention concerns an alternative method for a defined adjustment of the fill level of a flowable medium in a hollow body, with the following steps:
a) providing a tank;
b) placing the hollow body in the tank;
c) filling the tank with a flowable medium to a predefined fill height or to at least one predefined minimum fill height;
   wherein the predefined fill height or the predefined minimum fill height is selected in a manner such that after filling the tank, the opening or the openings of the hollow body are each below the level of the flowable medium situated in the tank;
d) in the event that this step d) is carried out after step c): positioning or mounting one or more channels each with a channel inlet and a channel outlet on the hollow body or on the tank in a manner such that at least one channel inlet is situated in each contiguous gas volume which is delimited by one or more internal walls of the hollow body as well as by the flowable medium, and wherein the channel outlets are respectively situated outside the hollow body and out of the flowable medium; or in the event that this step d) is carried out before step c): positioning or mounting one or more channels each with a channel inlet and a channel outlet on the hollow body or on the tank in a manner such that at least one channel inlet is situated in each contiguous gas volume which is formed and which is delimited by one or more internal walls of the hollow body as well as by the flowable medium as soon as the hollow body is placed in the filled tank in accordance with step b), and wherein the channel outlets are respectively situated outside the hollow body and outside the flowable medium as soon as step b) and step c) have been carried out.

Further aspects of the present disclosure are defined in the dependent claims or can be obtained from the description below.

### BRIEF DESCRIPTION OF THE DRAWINGS

The features will become apparent to the person skilled in the art from the detailed description of exemplary embodiments made with reference to the accompanying drawings, in which:

FIG. 1 diagrammatically shows a section through a first embodiment of the system in accordance with the invention for defined adjustment of the level of a flowable medium in a hollow body; and

FIG. 2 diagrammatically shows a section through a second embodiment of the system in accordance with the invention for defined adjustment of the level of a flowable medium in a hollow body.

### DETAILED DESCRIPTION

Preferred embodiments and features of the present invention will now be described in more detail with reference to the accompanying drawings, in which exemplary embodiments of the invention are shown. In the drawings, identical reference numerals refer to identical elements. In contrast, however, identical corresponding elements in different drawings may be provided with different reference numerals when a passage in the description refers to a quite specific drawing. Redundant descriptions have been left out. The term “and/or” as used here encom-passes any and all combinations of one or more of the associated listed elements. Furthermore, the use of “may” when embodiments of the present invention are described refers to “one or more embodiments of the present invention”.

It should be understood that expressions such as “first” and “second” are used for the description of different elements, but these elements are not limited by these expressions. These expressions are only used in order to distinguish one element from another element. As an example, a first element may be described as the second element and in similar manner, a second element may be described as a first element without affecting the scope of protection of the present invention.

In the description below of embodiments of the present invention, the use of the singular may also comprise the use of the plural as long as the context does not clearly indicate otherwise.

Relative expressions to describe spatial relationships such as “under” “below”, “over” “top”, “separated” and the like may be used below in order to simplify the description, wherein the spatial relationship of an element or feature with respect to another element or feature should then be interpreted as depicted in the drawings. If a figure contains a Cartesian coordinate system, then relative expressions may also refer to a coordinate system; this will be expressly indicated once again in the appropriate passage of the description. In particular in this regard, expressions such as “top”, “below”, “above”, “underneath”, “upwards”, “downwards” and the like should be understood to be with reference to the direction of the z-axis in the coordinate system, wherein the orientation of the z-axis should be understood to be “upwardly directed”. In the present context, “upwards”—i.e. in the orientation of the z axis—should also be understood to mean “against the direction of the force of gravity” which in the present context is always a given.

Clearly, the spatial relative expressions should additionally include the different orientations of the device used in the orientation depicted in the figures. If, for example, a device depicted in the drawings (and optionally at the same time also each of the incorporated coordination systems) is flipped/mirrored with respect to the horizontal of the figure in question, then elements which have been described as “under” other elements or features are then positioned “over” the other elements or features. Insofar as it does not contain any liquids, the device may be orientated differently (for example turned through 90° or in other orientations); in this case, the prepositions used here to describe spatial relationships will have to be interpreted differently.

It should also be understood that when a first element or a first layer is described as being “mounted on” a second element or a second layer, the first layer or the first element may be mounted directly on the second element or the second layer or, in fact, mounted by means of one or more intermediate further elements or layers on the second element or the second layer. Furthermore, it should also be understood that when an element or a layer is described as being “between” two other elements or layers, then the single element or the single layer may be between the other two elements or in fact one or more other intermediate elements or layers may be present.

Unless specifically defined differently, all of the terms used herein (including technical and scientific terms) respectively have the same meaning as generally understood by the person skilled in the art in the field to which the present disclosure belongs. Furthermore, it should be understood that terms as used in the commonly used dictionaries should be interpreted in a manner such that they have the meaning which agrees with their meaning in the context of the relevant prior art and/or the present specification, i.e. should not be interpreted in an idealised or overly formal sense, unless expressly stated to be the case.

In a first aspect, the invention concerns a system for defined adjustment of the level of a flowable medium in a hollow body. In this regard, the system has: a tank which is suitable for filling with a flowable medium; a hollow body with one or more openings; one or more channels each with a channel inlet (inlet opening) and a channel outlet (outlet opening). In this regard, the hollow body can be placed in the tank in a manner such that each of the one or more openings of the hollow body is respectively located completely below the surface (the level) of the flowable medium when the tank is filled with the flowable medium and a predefined minimum fill volume of flowable medium is situated in the tank. The channel is or the channels are respectively positioned in a manner such that after placing the hollow body in the tank filled with at least the minimum fill volume of the flowable medium, in those regions of the hollow body in which imprisoned volumes of gas are situated between the wall of the hollow body and the flowable medium, at least one respective channel inlet is situated and is connected through the one channel or one of the plurality of channels to a channel outlet which is situated outside the hollow body and outside the flowable medium.

Thus, the system has at least one channel which guides imprisoned volumes of gas or volumes of gas imprisoned while filling the tank through the flowable medium when the hollow body is placed in the tank filled with flowable medium and allows at least a portion of it to escape from the hollow body and raises the level of the flowable medium at least in sub-sections of the hollow body.

In particular, “can be placed” may also mean “can be mounted” or “positionable”. This means that the hollow body can thus be placed in the tank in a manner such that the hollow body remains in a predefined position and orientation relative to the position and orientation of the tank.

In one embodiment of the system, at least one of the channels has an at least partially V-shaped configuration.

In one embodiment of the system, at least one of the channels has an at least partially U-shaped configuration.

In embodiments, for example, all of the channels may have a U-shaped or V-shaped configuration. As an example, one, some or all of the channels may be configured in a manner such that their respective channel inlet (hereinafter also abbreviated to “inlet”) is connected inside the hollow body to its respective channel outlet (hereinafter also abbreviated to “outlet”) via the channel. In this context, “connected” means that the channel produces a “fluid communi-cation” between its inlet and its outlet, i.e. the flowable medium which gains ingress into the channel through the inlet can pass through the channel to its outlet and can then be discharged from that outlet.

As an example, for each of the U-shaped channels, the height of the vertical sections of the U-shaped channel may be between 1 and 50 millimetres and/or the length of the horizontal section of the U-shaped channel may be between 1 and 50 millimetres.

In one embodiment of the system, all of the channel inlets are disposed on one plane which is orientated orthogonally to the direction of gravitational force.

In one embodiment of the system, the tank is configured in a manner such that it permits the input of mechanical oscillations or resonant mechanical oscillations into a flowable medium situated in the tank. Preferably, the tank is at least partially produced from metal or plastic.

In one embodiment of the system, the tank is shaped in a manner such that it permits the input of mechanical oscillations or resonant mechanical oscillations with a working frequency of 15 to 1500 kilohertz, a mechanical output of 25 Watts to 20000 watts, with amplitudes of 0.5 to 80 μm into the flowable medium situated in the tank.

In one embodiment of the system, the tank has a maximum fill volume of between 1 millilitre and 5000 millilitres.

In one embodiment of the system, the tank has a connection or a plurality of connections which are respectively suitable for feeding the flowable medium into the tank and/or for discharging the flowable medium from the tank.

In one embodiment of the system, the hollow body is a sample holder, a microtitre plate or a sample array.

In one embodiment of the system, the hollow body is a microtitre plate with between 6 and 1536 wells.

In one embodiment of the system, the hollow body is a microtitre plate and the channels and respective channel inlets are disposed in a manner such that the level of a flowable medium can be raised at least in subsections by at least 0 to 10000 micrometres over the lower edge of the well bottoms.

In one embodiment of the system, for each of the channels, the channel inlet situated in the hollow body has an opening which is configured in a manner such that the surface tension of the flowable medium prevents penetration of the flowable medium into the U-channel.

Thus, the channel opening can in particular be tailored to a flowable medium (for example water) or a specific group of flowable media.

In embodiments of the system, the V-shaped channel (V-channel) or the U-shaped channel (U-channel) has an opening cross section of 10000 square micrometres to 100 square centimetres.

In one embodiment of the system, the hollow body has a plurality of internal segments which, when placing the hollow body in the tank or when filling the tank, allow a plurality of mutually separated imprisoned volumes of gas to be formed in the hollow body. In this regard, each of the internal segments is associated with at least one channel inlet when the hollow body is placed in the tank.

In one embodiment of the system, at least some of the channels function respectively as spacers between the lower edge of the hollow body and the bottom of the tank and which are respectively suitable for spacing the hollow body at a predefined distance from the tank bottom when the hollow body has been placed in the tank.

In one embodiment of the system, at least a portion of the channel consists of plastic, glass, ceramic or metal.

In one embodiment of the system, the channel is produced by injection moulding or 3D printing.

In one embodiment of the system, the channels are respectively attached or can be attached to the hollow body. This has the advantage that the channels respectively remain on the hollow body when the hollow body is lifted.

In one embodiment of the system, at least a portion of the hollow body consists of plastic or glass.

In one embodiment of the system, the system is enclosed in an atmosphere of gas.

In one embodiment of the system, the gas is ambient air.

In one embodiment, the system furthermore has a flowable medium. In this regard, the tank is filled with the flowable medium. The volume of the flowable medium in the tank corresponds to the prescribed minimum fill volume or is larger than the prescribed minimum fill volume. The hollow body is placed in the tank in the predefined position (i.e. in a manner such that after placing the hollow body in the tank which has been filled with at least the minimum fill volume of the flowable medium, in those regions of the hollow body in which imprisoned volumes of gas are situated between the wall of the hollow body and the flowable medium, there is at least one respective channel inlet which is connected to a channel outlet which is situated outside the hollow body and outside the flowable medium via the one channel or one of the plurality of channels).

In one embodiment of the system, the flowable medium is a liquid with a viscosity of 0.1 millipascal seconds to 200000 millipascal seconds and/or a temperature of 150 Kelvin to 400 Kelvin.

In a second aspect, the invention concerns a method for a defined adjustment of the fill level of a flowable medium in a hollow body, with the following steps:
a) providing a tank;
b) filling the tank with a flowable medium to a predefined fill height or to at least one predefined minimum fill height;
c) placing a hollow body in the tank in a manner such that the opening or the openings of the hollow body are respectively disposed below the level of the flowable medium situated in the tank;
d) in the event that this step d) is carried out after step c): positioning or mounting one or more channels each with a channel inlet and a channel outlet on the hollow body or on the tank in a manner such that at least one channel inlet is situated in each contiguous gas volume which is delimited by one or more internal walls of the hollow body as well as by the flowable medium, and wherein the channel outlets are respectively situated outside the hollow body and out of the flowable medium; or in the event that this step d) is carried out before step c): positioning or mounting one or more channels each with a channel inlet and a channel outlet on the hollow body or on the tank in a manner such that at least one channel inlet is situated in each contiguous gas volume which is formed and which is delimited by one or more internal walls of the hollow body as well as by the flowable medium as soon as the hollow body is placed in the filled tank in accordance with step c), and wherein the channel outlets are respectively situated outside the hollow body and outside the flowable medium as soon as step b) and step c) have been carried out.

In a third aspect, the invention concerns an alternative method for a defined adjustment of the fill level of a flowable medium in a hollow body, with the following steps:
a) providing a tank;
b) placing the hollow body in the tank;
c) filling the tank with a flowable medium to a predefined fill height or to at least one predefined minimum fill height;
   wherein the predefined fill height or the predefined minimum fill height is selected in a manner such that after filling the tank, the opening or the openings of the hollow body are each below the level of the flowable medium situated in the tank;
d) in the event that this step d) is carried out after step c): positioning or mounting one or more channels each with a channel inlet and a channel outlet on the hollow body or on the tank in a manner such that at least one channel inlet is situated in each contiguous gas volume which is delimited by one or more internal walls of the hollow body as well as by the flowable medium, and wherein the channel outlets are respectively situated outside the hollow body and out of the flowable medium; or in the event that this step d) is carried out before step c): positioning or mounting one or more channels each with a channel inlet and a channel outlet on the hollow body or on the tank in a manner such that at least one channel inlet is situated in each contiguous gas volume which is formed and which is delimited by one or more internal walls of the hollow body as well as by the flowable medium as soon as the hollow body is placed in the filled tank in accordance with step b), and wherein the channel outlets are respectively situated outside the hollow body and outside the flowable medium as soon as step b) and step c) have been carried out.

Some of the terms used in the present description of the invention will now be explained in more detail and/or defined for the context of this description.

“Flowable media” (hereinafter also abbreviated to “media”) are, for example, liquids, melts, liquid metals, dispersions, emulsions, cellular suspensions, pastes, dyes, polymers, res-ins, electrolytes, water, neutral, alkaline or acidic solutions, solvents, biocidal solutions, bases or acids or mixtures of the aforementioned substances. Flowable media may have a variety of viscosities from 0 millipascal seconds to 30000000000 millipascal seconds, preferably from 0.1 millipascal seconds to 200000 millipascal seconds, for example 50 millipascal seconds, and may be thixotropic or rheopectic, Newtonian or non-Newtonian, shear-thinning or shear-thickening. Flowable media may have a variety of temperatures from 0 Kelvin to 5000 Kelvin, preferably from 150 Kelvin to 400 Kelvin, for example 280 Kelvin.

“Gases” are, for example, fluids, air, ambient air, clean room air, nitrogen, oxygen, carbon dioxide, ozone, ethylene oxide, steam, plasma, supercritical or overcritical gases or mixtures of the aforementioned substances. The gases may have different temperatures from 0 Kelvin to 5000 Kelvin, preferably from 150 Kelvin to 400 Kelvin, for example 290 Kelvin.

“Tank” (“bath”) is a container or vessel which can be at least partially filled with a flowable medium. A tank may entirely or partially consist of plastic, glass, metal, ceramic, wood, plastic film, stainless steel, steel, titanium, aluminium, rubber, ice or a composite or a mixture of the aforementioned materials, preferably metal or plastic, for example stainless steel. The footprint of the tank may be between 1 and 100000 square centimetres, preferably between 10 and 1000 square centimetres, for example approximately 250 square centimetres. The footprint of the tank may be circular, rectangular, square, polygonal or irregular, preferably rectangular or circular, for example circular. The height of the tank may be between 0 and 10000 millimetres, preferably between 5 and 100 millimetres, for example approximately 10 millimetres. The maximum fill volume of a tank may be between 0 millilitres and 10000000 millilitres, preferably between 1 millilitres and 5000 millilitres, for example 100 millilitres. Preferably, a tank may be a lambda/2 element of a resonant oscillation system or be configured in a manner such that it enables the input of mechanical oscillations or resonant mechanical oscillations into the flowable medium in the tank. The tank may be at least partially transparent, non-transparent, translucent or opaque. In particular, a tank may be open at the top. In these cases, the tank has a concave shape.

The tank may have a connection or a plurality of connections for feeding or discharging the flowable medium. The tank may be equipped with a temperature sensor, fill level sensor or a pressure sensor.

“Hollow body” (for example a sample holder or a titre plate) is a body which has an interior space which is substantially completely enclosed by this hollow body (i.e. optionally except for openings). Here, hollow bodies are considered to be those which have at least one opening. In addition, the hollow bodies should always be configured in a manner such that the opening or the openings are situated in a lower region of the hollow body. In the context of the present description of the invention, a hollow body is therefore a vessel which is at least partially downwardly open. A hollow body is therefore characterized by the fact that when placing the hollow body in a tank filled with a flowable medium or when filling a tank in which a hollow body is situated with a flowable medium, a gas volume is imprisoned which, in the hollow body, causes a level of the flowable medium to be situated below the level of the flowable medium in the tank outside the hollow body. As an example, a hollow body may be an upturned beaker or a bottle lying on its side or a sample holder, a microtitre plate or a sample array, preferably a sample holder or a microtitre plate, for example a microtitre plate. A hollow body may at least partially consist of plastic, polystyrene, polyvinyl chloride, glass, ceramic, plastic film, metal, aluminium, stainless steel, rubber, steel or titanium or a composite or mixture of the aforementioned substances, preferably plastic, for example polystyrene. A hollow body may also enclose a plurality of compartments or segments, i.e. a plurality of interior spaces which are at least partially separated from each other.

Microtitre plates are laboratory tools for the investigation of, for example, biological or biochemical properties, for example for absorption measurements in photometers or for high throughput screening and pharmaceutical and plant protection research. The mainly rectangular microtitre plates usually consist of plastic. They contain between 1 and 1000, preferably between 6 and 1536, for example 96, individual mutually isolated wells (cavities) which are preferably disposed in rows and columns. The dimensions (length×width) of microtitre plates may, for example, be approximately 123 mm×85 mm. The wells are available in a variety of shapes such as, for example: F bottoms (flat bottoms), C bottoms (flat bottoms with minimally rounded corners), V bottoms (conically tapered bottoms), U bottoms (U-shaped depressions) and film bottoms (foil bottoms).

“Resonant oscillations” are mechanical (natural) oscillations of a component or a composite of components. During the oscillation, points of the component or of the composite of components move regularly about a rest position. In the context of the present invention, the oscillations may, for example, have a (working) frequency of 15 to 50000 kilohertz, preferably 15 to 500 kilohertz, for example 24 kilohertz and a mechanical output of over 1 Watt, preferably 25 Watts to 20000 Watts, for example 4000 Watts.

In order to produce resonant oscillations, piezoceramic or magnetostrictive oscillation generators are used. Linear oscillation generators and flat or curved plate oscillators or tubular oscillation generators are known. Resonant oscillations are used, inter alia, in measuring methods or in the treatment of liquids and other flowable media such as, for example, foodstuffs, biological samples, cellular suspensions, DNA samples, samples of pathogens, cosmetics, dyes, chemicals and nanomaterials. In this regard, resonant oscillations are input into flowable media, preferably into liquids, via a resonator with amplitudes of 0.01 to 350 μm, preferably 0.5 to 80 μm, for example 10 μm.

A “resonant oscillation system” may consist of one or more elements known as lambda/2 elements (λ/2 elements). An oscillation system consisting of a plurality of lambda/2 elements may be prepared from a piece of material of an appropriate length (the length λ/2) or may be composed of a plurality of components or component com-posites with length n λ/2 (n ϵ N, wherein N is the quantity of natural numbers), for example by screwing them together. Lambda/2 elements may have a variety of material cross sectional geometries, for example circular, oval or rectangular cross sections. The cross sectional geometry and cross sectional area may vary along the longitudinal axis of a lambda/2 element. The cross sectional area may be between 0.01 and 500 cm², preferably between 10 and 400 cm², for example approximately 250 cm².

Lambda/2 elements may, inter alia, be produced from metallic or ceramic materials or from glass, in particular from titanium, titanium alloys, steel or steel alloys, aluminium or aluminium alloys, for example from stainless steel. A lambda/2 element may be produced from a piece of material of appropriate length or consist of a plurality of pieces of material connected together.

Oscillation systems and lambda/2 elements which consist of more than one piece of material may be joined together in a variety of manners into a composite. A typical form of the composite is an oscillation system compressed by means of a centrally positioned tensioning element.

“Piezoelectric composite oscillation systems” consist of one or more lambda/2 elements connected together in the longitudinal direction, of which at least one lambda/2 element has one or more oscillation generating elements, preferably piezoceramic or magnetostrictive elements, for example piezoceramic elements, in the form of disks, rings, disk segments or ring segments, piezo films or piezo plates, for example piezo rings. A lambda/second element of this type is termed an “active lambda/2 element”. A lambda/2 element without an oscillation generating element is termed a passive lambda/2 element.

“Passive lambda/2 elements” without oscillation generating elements may be mechanically connected to one or more of the aforementioned active lambda/2 elements in a manner such that the mechanical oscillations are transmitted partially or in their entirety, preferably substantially entirely, with small losses (<10%) from the active lambda/2 element to the passive lambda/2 element.

Other lambda/2 elements without oscillation generating elements may be mechanically connected to the aforementioned passive lambda/2 element in a manner such that the mechanical oscillations are transmitted partially or in their entirety, preferably substantially entirely, with small losses (<10%) from a passive lambda/2 element to the connected passive lambda/2 element.

The active and passive lambda/2 elements are usually connected together by screwing at the maximum or close to the maximum of the oscillation deflection, for example in the longitudinal direction of the oscillation propagation direction.

Straight piezoceramic resonant oscillation systems demand an enhanced surface pressure on the coupling site between two lambda/2 elements. This surface pressure can be between 0.1 and 1000 N/mm², preferably between 1 and 10 N/mm², for example 5 N/mm². The surface pressure has considerable effects on the efficiency, the maximum possible mechanical transmission efficiency and the resonance frequency. Thus, inter alia, the surface pressure can be selected in a manner such that the efficiency is max-imized and/or the losses on transfer of the mechanical oscillations are minimised.

The surface pressure between an active lambda/2 element and a passive lambda/2 element, between two active lambda/2 elements or between two passive lambda/2 elements is usually produced by means of at least one tensing element, for example by means of a centrally positioned tension screw, for example a steel screw or a titanium threaded rod.

When inserting a hollow body into a tank filled with flowable medium or when filling a tank in which a hollow body is situated with a flowable medium, a gas volume is imprisoned which, in the hollow body, at least partially causes a level of the flowable medium to go below the level of the flowable medium in the tank outside the hollow body. This level might lie below the level which is necessary for a technical method, for example for the transmission of oscillations. In addition, the gas volume imprisoned in the hollow body might result in an unwanted buoyancy or floating of the hollow body.

With the disclosed invention, when placing the hollow body in the tank or when filling the tank, the volumes of gas imprisoned in the hollow body can be partially or completely reduced, preferably partially reduced. In this way, the level of the flowable medium is raised at least in sub sections of the hollow body, for example in order to enable specific technical methods to be carried out. In the case of microtitre plates or sample arrays, with the disclosed invention, the level of the flowable medium can be raised at least in sub sections by 1 to 50000 micrometres, preferably 10 to 10000 micrometres, for example 2000 micrometres above the lower edge of the well bottoms or of the sample vessel bottoms.

In accordance with the invention, this is obtained by means of at least one channel —which may be at least partially U-shaped or V-shaped in configuration (both referred to jointly below as “U-shaped”), which conducts at least a portion of the gas imprisoned in the hollow body through the flowable medium and therefore allows it to escape from the hollow body.

The at least partially V-shaped or U-shaped channel, for example, (hereinafter both designated as a U-channel) may at least partially consist, for example, of plastic, a mixture of substances, acrylic ester-styrene-acrylonitrile, acrylonitrile-butadiene-styrene co-polymers, aluminium, silver, gold, biopolymers, calcium sulphate dihydrate, cellulose, Cx5, flexible filaments, thermoplastic elastomers, high impact polystyrene, laurolactam, metal, min-eral, polyamides, polycaprolactam, polycarbonate, polyether etherketone, polyetherimide, pol-yethylene terephthalate, polyhydroxy fatty acid, polyimides, polylactides, polymers, polymethyl methacrylate, polyvinyl alcohol, titanium, polylactic acids, polystyrene, polyvinyl chloride, glass, ceramic, stainless steel, rubber or steel, or a composite or a mixture of the aforementioned substances, preferably polymer, for example polylactic acids. The channel (preferably a U-channel) may, for example, be produced by injection moulding, milling, drilling, erosion, extrusion or 3D printing, preferably by injection moulding or 3D printing, for example 3D printing. The channel has at least one channel for the passage of gas with an opening cross section of at least one square micrometre, preferably from 10000 square micrometres to 100 square centimetres, for example 4 square millimetres. The opening of the channel in the hollow body may be configured in a manner such that the surface tension of the flowable medium prevents penetration of the flowable medium into the channel. In the case of a U-shaped channel (and in this case not a V-shaped channel), the height of the vertical sections 73a, 73b, 74a, 74b of the U-channel may be between 1 and 300 millimetres, preferably between 1 and 50 millimetres, for example 6 millimetres. The length of the horizontal section 72a, 72b of the U-channel may be between 1 and 300 millimetres, preferably between 1 and 50 millimetres, for example 5 millimetres.

When the hollow body has a plurality of internal segments which generate the appear-ance of a plurality of imprisoned volumes of gas which are separated from each other when the hollow body is placed in the tank or when the tank is filled, then preferably, a channel may end on the side of each of these volumes of gas.

A U-channel may preferably be configured in a manner such that it functions as a spacer between the lower edge of the hollow body and the bottom of the tank.

In the present context, the height of the substantially flat top surface of a flowable medium in a container or vessel (hereinafter abbreviated to “vessel”)—or in a subregion of the vessel—is described as the “level”, wherein the flowable medium is under the influence of gravitational force and wherein the flowable medium is substantially at rest or when the flowable medium would be substantially at rest in the vessel. The “top surface” in this regard here should be understood to mean that surface by which the volume of the flowable medium is upwardly limited (i.e. against the force of gravity) without contacting the vessel or solid objects in the vessel. In other words, the “top surface” of the flowable medium is that (virtual) surface which entirely follows the volume of the flowable medium which has formed in the vessel and above which there is no flowable medium and in addition, at the same time does not form a part of the surface of the vessel or an object situated in the vessel. Any gaseous inclusions in the flowable medium (bubbles) should be disregarded here.

Furthermore, “height” is a measure of the position along a (virtual) axis which is orientated against the force of gravity. The fill level of a flowable medium in a vessel is therefore determined by the height of the level of the flowable medium in the vessel.

Special embodiments of the invention will now be described in more detail. For the purposes of illustration of the technical background or for comparison purposes, reference will occasionally also be made to the prior art and for this purpose will be briefly explained or outlined in one or more figures.

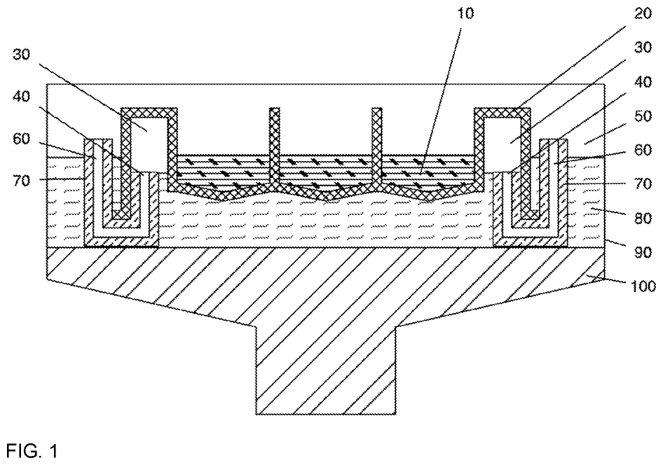

FIG. 1 diagrammatically shows a section through a first embodiment of the system in accordance with the invention for defined level adjustment of a flowable medium in a hollow body. For simplification of the description, a Cartesian coordinate system is also drawn in, with x, y and z axes. In this regard, the z axis is orientated against the force of gravity, which is considered to be a given. The terms “top” and “bottom” as well as terms deriving from this such as “upwards” or “above” and the like are with respect to the z axis which should be assumed to be the upward direction.

A liquid suspension 10 at a temperature of 290K, for example, is situated in a microtitre plate 20 for the purposes of the investigation of biochemical properties. The microtitre plate 20 may be produced from polystyrene. In order to receive the suspension 10, the microtitre plate 20 may, for example, have 12 wells each with conical bottoms which are disposed in the manner of a matrix in 3 columns and 4 rows on the upper side (outside 22, see below) of the microtitre plate 20. In the cross section of FIG. 1, 3 wells 88a, 88b and 88c can be seen, each of which being filled with the suspension 10 to be investigated. In particular, the microtitre plate 20 is configured as a hollow body. In this regard, the hollow body has an opening which is formed between the side walls 26a, 26b (below the virtual plane E₁). The region between the microtitre plate 20 and the virtual plane E1 may therefore be described as the internal region of the hollow body formed by the microtitre plate 20. Thus, the hollow body furthermore has an outside 22 as well as an inside 24.

The microtitre plate 20 is positioned inside a tank 90 which can be filled with an aqueous solution 80 (flowable medium). The tank 90 may, for example, have an internal diameter of 21 centimetres and a height of 2 centimetres. In order to allow the input of resonant mechanical oscillations (for example oscillations with a frequency of 24 kHz and an amplitude of 10 micrometres), the metal tank 90 is connected to a resonator 100.

When filling the tank 90 with the aqueous liquid 80, which has a viscosity of approximately 1 millipascal seconds and a temperature of approximately 280 Kelvin, for example, ambient air is imprisoned in two segments 30a, 30b of the hollow body formed by the microtitre plate 20. In other words, a specific volume of ambient air is imprisoned in the region of segments 30a, 30b respectively by the inner wall 24 (underside) of the hollow body formed by the microtitre plate 20 as well as the surface 82a, 82b of the aqueous liquid 80 in the region of the segments 30a, 30b. By means of the imprisoned volume of air—which has a lower density than the aqueous solution 80 and therefore is situated above the surfaces 82a, 82b of the aqueous solution 80—in the region of the segments 30a, 30b, aqueous solution is displaced of the region of the segments 30a, 30b or can penetrate into the segments 30, 30b respectively only up to the underside of the respectively imprisoned volume of air.

However, now, at least a portion of the air respectively imprisoned in the upper region of the segments 30a, 30b can escape through inlet openings 42a, 42b of two U-shaped channels 70a, 70b (U-channels). The respective volume in the region of the segments 30a, 30b is therefore reduced so that respectively, less aqueous solution 80 is displaced in the region of the segments 30a, 30b or aqueous solution 80 can come in from below into the segments 30a, 30b until the level of the liquid 80 reaches the upper edge of the inlet openings 42a, 42b. Air imprisoned in the upper region of the segments 30a, 30b can now be dissipated through the respective internal regions 60a, 60b of the channels 70a or 70b and can escape through the respective outlet openings 44a, 44b of the channels 70a, 70b into the ambient air. To this end, the outlet openings 44a, 44b are respectively positioned outside the hollow body formed by the microtitre plate in a manner such that they are situated in the region of the ambient air. In the example shown, the outlet openings are above the level 83a, 83b of the aqueous solution 80 in respective regions outside the microtitre plate 20 (here, referring to FIG. 1, disposed in the region between the left hand side wall 92a of the tank 90 and the left hand side wall 26a of the microtitre plate 20 as well as in the region between the right hand side wall 92b of the tank 90 and the right hand side wall 26b of the microtitre plate 20).

In the exemplary embodiment shown, the inlet openings 42a, 42b are situated at the same height, i.e. they are disposed in a common plane E₂ orthogonally to the z direction of the coordinate system. This means that the level of the aqueous solution 80 is kept at or set at the same height in both segments 30a, 30b.

The two U-shaped channels may, for example, be produced from a polymer by 3D printing. The cross section of the internal regions 60a, 60b of the channels 70a or 70b as well as the cross section of the inlet openings 42a, 42b and the outlet openings 44a, 44b is respectively 4 square millimetres, for example. In particular, inlet openings of this order of magnitude prevent penetration of the aqueous solution 80 into the channels 70a, 70b in the event that the inlet openings 42a, 42b should become situated below the level of the aqueous solution in the region of the segments 30a, 30b—for example during filling of the tank 90. The level of the aqueous solution 80 after the escape of the imprisoned air can therefore in particular be adjusted in this manner such that it is then approximately 2000 micrometres over the lower edge of the bottoms of the wells 88a, 88b, 88c.

Furthermore, in the exemplary embodiment of FIG. 1, the U-channels 70a, 70b are shaped in a manner such that they each grip the lower edge of the microtitre plate 20 in regions 27a, 27b, and therefore when the microtitre plate 20 is lifted—and therefore in particular when the microtitre plate 20 is removed from the tank 90—they remain on said regions 27a, 27b of the lower edge of the microtitre plate 20.

In addition, the external geometry of the U-channels 70a, 70b is dimensioned such that the horizontal portion 72a, 72b of the U-channels (at least in the z direction) has an external diameter of 2 millimetres. In this manner, a constant distance of 2 millimetres is maintained between the lower edge of the microtitre plate 20 and the bottom of the tank 90. In the exemplary embodiment shown, the U-shaped channels 70a, 70b therefore also act as a support or holding device for the microtitre plate 20 or as a positioning device for the microtitre plate 20 in the tank 90.

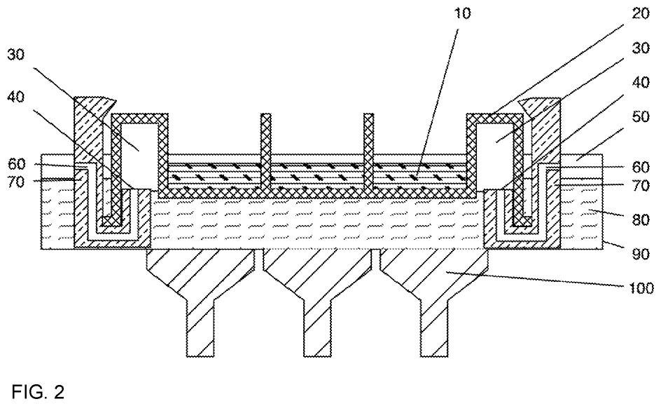

FIG. 2 diagrammatically shows a section through a second embodiment of the system in accordance with the invention for the defined adjustment of the level of a flowable medium in a hollow body. For simplification of the description, again, a Cartesian coordinate system with x, y and z axes has also been drawn in. The statements made about the coordinate system in this regard with reference to FIG. 1 are also of relevance here.

A liquid cellular suspension 10 at a temperature of 278K is situated in a polystyrene microtitre plate 20 for the purposes of ultrasound lysis. On the microtitre plate 20 there are 6 wells with flat bottoms which are disposed on the microtitre plate 20 in 2 columns and 3 rows. In the cross section of FIG. 2, 3 wells 88a, 88b, 88c can be seen which are each filled with the cellular suspension 10 to be investigated. In similar manner to the exemplary embodiment of FIG. 1 described above, the microtitre plate 20 of the embodiment shown in FIG. 2 is also configured as a hollow body. The statements regarding the geometry of the microtitre plate in respect of FIG. 1 are also relevant to FIG. 2, with the exception of the configuration of the well bottoms. In particular, here too, the polystyrene microtitre plate 20 configured as a hollow body therefore has an outside 22 as well as an inside 24.

The polystyrene microtitre plate 20 is positioned inside a tank 90 which can be filled with a liquid (flowable medium). As an example, the tank 90 may have an internal diameter of 30 centimetres and a height of 3 centimetres.

In order to receive resonant mechanical oscillations (for example oscillations with a frequency of 24 kHz and an amplitude of 12 micrometres), the metal tank 90 is connected to three resonators 100a, 100b, 100c.

When filling the tank 90 with a coupling liquid 80 which has a viscosity of approximately 500 millipascal seconds and a temperature of approximately 280 Kelvin, for example, ambient air becomes imprisoned in each of two segments 30a, 30b in the hollow body of the microtitre plate 20. The statements made in this regard with reference to the embodiment shown in FIG. 1 are also of relevance in this case. The imprisoned air can escape through inlet openings 42a, 42b in two U-channels 70a, 70b until the level of the liquid 80 reaches the upper edge of the inlet openings 42a, 42b. Air imprisoned in the upper region of the segments 30a, 30b can now be dissipated through the respective internal regions 60a, 60b of the channels 70a or 70b and escape into the ambient air through the respective outlet openings 44a, 44b of the channels 70a, 70b. To this end, the outlet openings 44a, 44b are respectively positioned outside the hollow body formed by the microtitre plate in a manner such that they are situated in the ambient air region. In the example shown, the outlet openings are above the level 83a, 83b of the liquid 80 in respective regions outside the microtitre plate 20 (here, with reference to FIG. 1, disposed in the region between the left hand side wall 92a of the tank 90 and the left hand side wall 26a of the microtitre plate 20 as well as in the region between the right hand side wall 92b of the tank 90 and the right hand side wall 26b of the microtitre plate 20).

In the exemplary embodiment shown, the inlet openings 42a, 42b are situated at the same height, i.e. they are disposed in a common plane E₂ orthogonally to the z direction of the coordinate system. This means that the level of the aqueous solution 80 is kept at or set at the same height in both segments 30a, 30b.

The two U-shaped channels may, for example, be produced from a polymer by injection moulding. The cross section of the internal regions 60a, 60b of the channels 70a or 70b is 6 square millimetres, for example. In particular, inlet openings of this order of magnitude prevent penetration of the aqueous solution 80 into the channels 70a, 70b in the event that the inlet openings 42a, 42b should become situated below the level of the aqueous solution in the region of the segments 30a, 30b—for example during filling of the tank 90. The level of the aqueous solution 80 after the escape of the imprisoned air can therefore in particular be adjusted in this manner such that it is then approximately 1000 micrometres over the lower edge of the bottoms of the wells 88a, 88b, 88c.

Furthermore, in the exemplary embodiment of FIG. 2, the U-channels 70a, 70b are shaped in a manner such that they each grip the lower edge of the microtitre plate 20 and therefore they remain thereon when the microtitre plate 20 is lifted. To this end, the channels 70a, 70b respectively have a clip 76a, 76b in their upper region which protrudes out over the microtitre plate 20 and protrudes inwardly over the upper side 29a, 29b of the corresponding segment 30a, 30b by means of a respective nose 77a, 77b and therefore can be clamped to it in this manner.

In addition, the U-channels 70a, 70b are dimensioned such that the horizontal portion 72a, 72b of the U-channels has an external diameter of 3 millimetres (at least in the z direction). In this manner, a constant distance of 3 millimetres is maintained between the lower edge of the microtitre plate 20 and the bottom of the tank 90. In the exemplary embodiment shown, the U-shaped channels 70a, 70b therefore also act as a support or holding device for the microtitre plate 20 or as a positioning device for the microtitre plate 20 in the tank 90.

1. A system for defined adjustment of the level of a flowable medium in a hollow body, the system comprising:
a tank suitable for filling with a flowable medium;
a hollow body with one or more openings; and
one or more channels,
wherein
each channel of the one or more channels comprising a channel inlet and a channel outlet,
the hollow body is disposable within the tank in a manner such that each of the one or more openings of the hollow body is respectively situated completely below the surface of the flowable medium when the tank is filled with the flowable medium and a minimum fill volume of flowable medium is disposed within the tank;
at least one channel of the one or more channels is positioned in a manner such that after placing the hollow body in the tank filled with at least the minimum fill volume of the flowable medium, in those regions of the hollow body in which imprisoned volumes of gas are situated between the wall of the hollow body and the flowable medium, at least one channel inlet is situated and is connected through the at least one channel of the one or more channels to a channel outlet which is situated outside the hollow body and outside the flowable medium.

2. The system of claim 1, wherein at least one channel of the one or more channels has an at least partially V-shaped configuration.

3. The system of claim 2, wherein at least one channel of the one or more channels is a U-shaped channel having an at least partially U-shaped configuration and a height of vertical sections of the U-shaped channel is between 1 and 50 millimetres and/or a length of a horizontal section of the U-shaped channel is between 1 and 50 millimetres.

4. The system of claim 1, wherein the channel inlets of the one or more channels are disposed on one plane that is orientated orthogonally to the direction of gravitational force.

5. The system of claim 1, wherein the tank is configured such that the tank permits an input of mechanical oscillations or resonant mechanical oscillations into a flowable medium disposed within the tank and the tank is at least partially produced from metal or plastic.

6. The system of claim 1, wherein the tank has a connection or a plurality of connections which are respectively suitable for feeding the flowable medium into the tank and/or for discharging the flowable medium from the tank.

7. The system of claim 1, wherein the hollow body is a sample holder, a microtitre plate, or a sample array.

8. The system of claim 1, wherein, for each channel of the one or more channels, the channel inlet situated in the hollow body has an opening which is configured such that surface tension of the flowable medium prevents penetration of the flowable medium into each channel.

9. The system of claim 1, wherein the hollow body has a plurality of internal segments which, when placing the hollow body in the tank or when filling the tank, allow a plurality of mutually separated imprisoned volumes of gas to be formed in the hollow body and each of the internal segments is associated with at least one channel inlet when the hollow body is placed in the tank.

10. The system of claim 1, wherein at least some of the channels function as spacers between a lower edge of the hollow body and a bottom of the tank and are configured for spacing the hollow body at a predefined distance from the tank bottom when the hollow body has been placed in the tank.

11. The system of claim 1, wherein the one or more channels are attachable to the hollow body.

12. The system of claim 1, further comprising a flowable medium, wherein the tank is filled with the flowable medium, a volume of the flowable medium in the tank corresponds to at least the minimum fill volume or is larger than the minimum fill volume, and the hollow body is placed in the tank in the predefined position.

13. A method for a defined adjustment of the fill level of a flowable medium in a hollow body, the method comprising:
a) providing a tank;
b) filling the tank with a flowable medium to a predefined fill height or to at least one predefined minimum fill height;
c) placing a hollow body in the tank such that the opening or the openings of the hollow body are respectively disposed below the level of the flowable medium situated in the tank; and
d) positioning or mounting, if carried out after c), one or more channels, each channel having a channel inlet and a channel outlet on the hollow body or on the tank, such that at least one channel inlet is situated in each contiguous gas volume that is delimited by one or more internal walls of the hollow body and the flowable medium, wherein the channel outlets are disposed outside the hollow body and out of the flowable medium
or
positioning or mounting, if carried out before c), one or more channels, each channel having a channel inlet and a channel outlet on the hollow body or on the tank, such that at least one channel inlet is situated in each contiguous gas volume that is formed and that is delimited by one or more internal walls of the hollow body and the flowable medium as soon as the hollow body is placed in the filled tank in accordance with c),
wherein the channel outlets are disposed outside the hollow body and outside the flowable medium as soon as b) and c) have been carried out.

14. A method for a defined adjustment of the fill level of a flowable medium in a hollow body, the method comprising:
a) providing a tank;
b) placing a hollow body in the tank;
c) filling the tank with a flowable medium to a predefined fill height or to at least one predefined minimum fill height;
wherein the predefined fill height or the predefined minimum fill height is selected such that, after filling the tank, an opening or openings of the hollow body are each below the level of the flowable medium situated in the tank; and
d) positioning or mounting, if carried out after c), one or more channels each with a channel inlet and a channel outlet on the hollow body or on the tank such that at least one channel inlet is situated in each contiguous gas volume that is delimited by one or more internal walls of the hollow body and by the flowable medium, and wherein the channel outlets are respectively situated outside the hollow body and out of the flowable medium
or
positioning or mounting, if carried out before c), one or more channels, each channel having a channel inlet and a channel outlet on the hollow body or on the tank, such that at least one channel inlet is situated in each contiguous gas volume that is formed and that is delimited by one or more internal walls of the hollow body and by the flowable medium as soon as the hollow body is placed in the filled tank in accordance with b),
wherein the channel outlets are disposed outside the hollow body and outside the flowable medium as soon as b) and c) have been carried out.
